(19) United States
(12) Patent Application Publication
(10) Pub. No.: US 2012/0213513 A1
(43) Pub. Date: Aug. 23, 2012

(54) Direct generation semiconductor IRCM laser system

(75) Inventor: Christopher J. Chao, South Pasadena, CA (US)

(73) Assignee: BAE SYSTEMS INFORMATION AND ELECTRONIC SYSTEMS INTEGRATION, INC.

(21) Appl. No.: 12/932,153

(22) Filed: Feb. 18, 2011

(51) Int. Cl. H04K 3/00; G21K 5/00

(52) U.S. Cl. 398/39; 250/495.1

(57) ABSTRACT

Direct generation semiconductor infrared countermeasure lasers are provided that can be independently modulated and combined so as to provide a simultaneously-generated multi-spectral output for the beam. The countermeasure system is smaller and more lightweight than conventional IRCM laser systems, is less expensive, is non-cryogenically cooled and is configurable for multi-spectral generation with asynchronous jam codes in which the spectral distribution can be customized by combining multiple emitters with a range of center wavelengths.

### FIELD OF THE INVENTION

This invention relates to infrared countermeasures utilizing lasers and more particularly to the utilization of a direct generation semiconductor IRCM laser in which infrared energy is directly generated and in which separate semiconductor lasers operating in different energy bands provide the opportunity for optimal simultaneously generated waveforms for each band to defeat threats in shorter timelines with independent intensity control of band outputs for spectral distribution control.

### BACKGROUND OF THE INVENTION

Infrared countermeasure systems historically have involved wide field of view broadband jammers that use plasma discharge lamps or hot glowing heat element lamps and disperse energy in a wide area. These types of systems are being replaced with directed energy systems involving pointed lasers, with these systems being known as directed IR countermeasures or DIRCM systems

The lasers utilized in these systems have typically involved gas lasers and optical parametric oscillators. Optical parametric oscillator systems require an optical pumping stage and as a result the mean time to failure for the system is lowered. The use of optical parametric oscillators results in a less reliable system with higher weight and complexity.

More importantly, when using optical parametric oscillators, the purpose of the optical parametric oscillator is to take incoming energy at one wavelength and convert it into a number of different wavelengths. It will be appreciated that the number of different wavelengths generated in this manner may not all be useful in countermeasuring and thus result in lost energy, which results in reduced wall-plug or total efficiency.

More importantly, in order to modulate these laser systems with the appropriate jam codes, i.e. temporal waveforms comprised of laser output power designed to confuse heat seeking missiles, only one jam code can be generated for all of the bands of interest. This is because the jam code is generated prior to laser light being introduced into the optical parametric oscillator. Thus, the jam codes for each band are generated simultaneously, with the jam codes for each of the bands involved being identical. The fact that these jam codes are identical means that the one jam code that is generated cannot be made optimal for a particular mid-infrared band. Typically the optimal jamming codes for these bands are different due to different threat characteristics.

When utilizing optical parametric oscillators the challenge is to develop a hybridized generic jam code that addresses all the different bands in which threats operate. Alternatively, the jammer waveform can be comprised of sequential segments, each optimized for a specific threat or class of threats. In either case the optimal waveform for all threats is not transmitted as quickly as it could be.

The problem in all optical parametric oscillators is that wavelengths are created in optical-to-optical transmissions along the beam line to get all the beam wavelengths that are required. This requires that the jam code have the same temporal characteristics. What this means is that if one looks at the energy pulses coming out of the device, they are synchronized in time. However, each of the wavelengths in each of the IR bands is addressing a different class of threats. These classes of threats are addressed most optimally by specific and usually different waveform combinations or jam codes.

Thus, in order to be able to accommodate all the different types of threats encountered, either there has to be a trade-off in the code utilized such as the aforementioned hybridized generic code that address all the different bands or threats; or an optimal jam code for each band has to be sequentially generated in a segmented fashion. Segmentation takes time, for instance a number of seconds or a fraction thereof, in order to generate an optimized code for a particular band. After the optimized code has been generated then the system switches over to the next segment of time to address the optimal code for a different wavelength range and a different class of threats.

The result is either that there is no generalized optimized waveform which is optimally capable of countermeasuring all threats, or one has to cycle through the modulation sequences a number of times.

Note, the segmentation time is significant when compared to the time between the output from a missile warning system and the time of impact by the missile at the target. Typically the missile impacts the target within a few seconds, thus limiting the segmentation durations that are available. Thus time is an extremely valuable commodity and the faster that one can apply the correct code and get the right energy impinging on the missile head, the more likely the target platform will be able to survive the engagement.

As to optical parametric oscillators, typically one goes through either a single or dual optical parametric oscillator wavelength conversion that starts off with a pump laser lasing at the highest frequency or lowest wavelength. The energy emitted by the pump laser then passes through a crystal that will generate one or more extra wavelengths. In some embodiments the procedure may go through another crystal phase.

As mentioned above, one of the difficulties in generating collimated light in this fashion is that one requires different optimized jam codes for different threats. Due to the difference in jam codes, it is desirable to run all bands asynchronously so that an optimized jam code can be running simultaneously against the threat using whatever code works best for countermeasuring the threat. There is a significant disadvantage to using the synchronized code associated with optical parametric oscillators because one cannot produce simultaneous asynchronous optimized codes.

Secondly, having multiple optical-to-optical stages is sub-optimal from an efficiency perspective because of the inherent inefficiency of each stage, manifested by either heat or unused optical radiation that is produced outside the desired spectral range. Additionally, due to the heat production, many of the optical parametric oscillators are cryogenically cooled, which is expensive and failure prone. Moreover, reliability as well as complexity makes optical parametric oscillator systems less desirable.

Another problem with the present DIRCM systems is the ability to be able to tailor the spectral content of the outgoing beam to be optimal for a number of different bands. It is of course useful to be able to simulate the output of a jet engine. This requires that certain wavelengths be available in the output beam. More importantly, it is important to be able to control what is known as the ratio of the intensities of the wavelengths, or color temperature ratio, so as to be able to either simulate the output of a jet engine, or to optimally affect the seeker head of an incoming missile.

With optical parametric oscillators the color temperature ratio is not easily adjustable. Nor is it possible with current DIRCMs to customize a spectral distribution by combining multiple emitters with a range of center wavelengths, and presently this is not done.

In order to countermeasure a missile, the laser output must hit the missile dome which also sees the target engine. In order to countermeasure the missile one needs to make the missile track the laser by overcoming the intensity of the output of the engine. Not only is optical power important in this context, also the wavelengths at which the laser operates is important, as well as the jam code.

In terms of intensity, one needs to take into account atmospheric absorption which is a function of wavelength and one must have the ability to choose a wavelength range at which both atmospheric attenuation is minimized and missile detector response is maximized. Present systems are fabricated such that one is to choose the center wavelength and width of the distribution and tailor it such that one is in a highly transmissive portion of the atmosphere in the bands of interest. Typically the US Navy IRCM bands of interest are bands 1, 2 and 4.

### SUMMARY OF INVENTION

Rather than utilizing optical parametric oscillators and pumping lasers, in the subject invention one or more semiconductor lasers have their outputs utilized directly, in what is termed direct generation. This means that the simplest architecture is involved in which one has electrons in and photons out. By way of definition, direct generation is taken to mean electrical-to-optical direct transformation into a particular wavelength range of interest. This is in contrast to optical parametric oscillators which involve electrical-to-optical pumping lasers that do not produce radiation in the appropriate band. As will be appreciated, the electrical-to-optical pumping laser output is coupled to an optical parametric oscillator in an optical-to-optical phase in which the pumping laser output is down converted.

In the subject invention semiconductor lasers are utilized which are either diode lasers or quantum cascade structures that operate utilizing direct generation to output the wavelengths of interest.

Because one can utilize individual semiconductor lasers and modulate them independently, and because one can also provide different wavelengths for different semiconductor lasers, one can provide an optimal jam code for each band. One can then combine the outputs of multiple semiconductor lasers to provide a simultaneously-generated multi-band output, with each of the bands being modulated with the optimal jam code, or in fact operated in a CW or FM mode. This means that there are multiple modes of operation possible, namely pulsed, Quasi-CW and CW modes, with duty cycles from 0-100% in all bands. Moreover, there is waveform amplitude control, as well as color ratio control. Additionally, the output intensity of these direct generation lasers is independently controlled so that any color temperature can be simulated.

Further, the semiconductor lasers when operating in a direct generation mode are wavelength-tunable in bands 1, 2 and 4, with the spectral distribution customized by combining multiple emitters with a range of center wavelengths. The temperature profile of the combined emitters can thus be tailored by tailoring the outputs of the individual lasers to provide color ratio control.

Moreover, with independent control of the waveforms in each IR band, there is a reduced Missile Threat Defeat Timeline and this is due to the elimination of Jam Code segmentation. Waveform flexibility also enables open and closed loop IRCM operation.

Further, there is a high wall plug efficiency due to the single electrical-optical phase associated with direct generation.

It will be noted that the entire direct generation jammer, rather than being on the order of 60 pounds, is on the order of 12 pounds and need not be cryogenically cooled. Additionally, the use of individual and combined semiconductor lasers when operating in the direct generation mode provides a multifunction capability capable of active tracking and closed loop control, as well as being operatable in the CW mode for advanced threats, or in a reticle jamming QCW mode, as well as a pulsed active mode.

For the bands 1 and 2, conventional diode lasers can be utilized, whereas for band 4, quantum cascade devices provide direct generation. For the bands 1 and 2 gallium antimonide and indium phosphide based semiconductor materials are usable. Note, as rough estimate, the average power that is required is on the order of 1 watt.

It will be noted that because the output of optical parametric oscillators involve very narrow pulses, it is another feature of using a direct generation semiconductor lasers that one can utilize much wider pulses. While it is true that semiconductor lasers have not demonstrated the high peak power per cavity of optical parametric oscillators, because of the wide pulse widths the output power of direct generation lasers is high enough. Moreover, the ability to produce wider pulses is in some cases is extremely useful for certain countermeasure applications. Also, semiconductor lasers can be operated in the CW (continuous wave) mode and utilized without jam codes for more optimally defeating some missile threats. Note that it is not possible to utilize an optical parametric oscillator device in a CW mode.

Finally, there is a distinct advantage to having a simultaneously-generated multi-spectral output. For optical parametric oscillator systems, one has to sequence through the various waveform segments to provide optimal Jam Codes for each band. This sequencing is time consuming and results in unacceptably long delays. With direct generation semiconductor lasers, each portion of the multi-spectral output can be generated simultaneously, thus eliminating sequencing or segmentation.

In summary, what is provided is the utilization of direct generation semiconductor infrared countermeasure lasers which can be independently modulated and combined so as to provide a simultaneously-generated multi-spectral output beam. The countermeasure system is smaller and more lightweight than conventional IRCM laser systems, is less expensive, is non-cryogenically cooled and is configurable for multi-spectral generation with asynchronous jam codes in which the spectral distribution can be customized by combining multiple emitters with a range of center wavelengths. Moreover, architectural simplification via removal of the need for optical pumping increases reliability and reduces cost of the laser unit.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of a direct generation semiconductor DIRCM laser system in which direct generating semiconductor lasers are modulated by three different modulators, the outputs of which being directed and combined to provide a multi-spectral output, with each band having a different modulation characteristic;

FIG. 2 is a diagrammatic illustration of the utilization of pairs of direct generation semiconductor laser sources having orthogonally oriented polarized outputs which are combined by a thin film polarizer, thus to double the output energy available from a single semiconductor laser;

FIG. 3 is a diagrammatic illustration of the use of an array of semiconductor lasers operated without the use of collimating optics for a wide field of view or coverage angle such that with always-on lasers, there is no need to point the lasers and therefore no need for a threat warning detector;

FIG. 4 is a diagrammatic illustration of a lamp-based jammer module having a turret containing an array of semiconductor lasers mounted atop the lamp-based jammer module; and,

FIG. 5 is a diagrammatic illustration of the omni-directional coverage associated with a ring array of direct generation semiconductor lasers.

### DETAILED DESCRIPTION

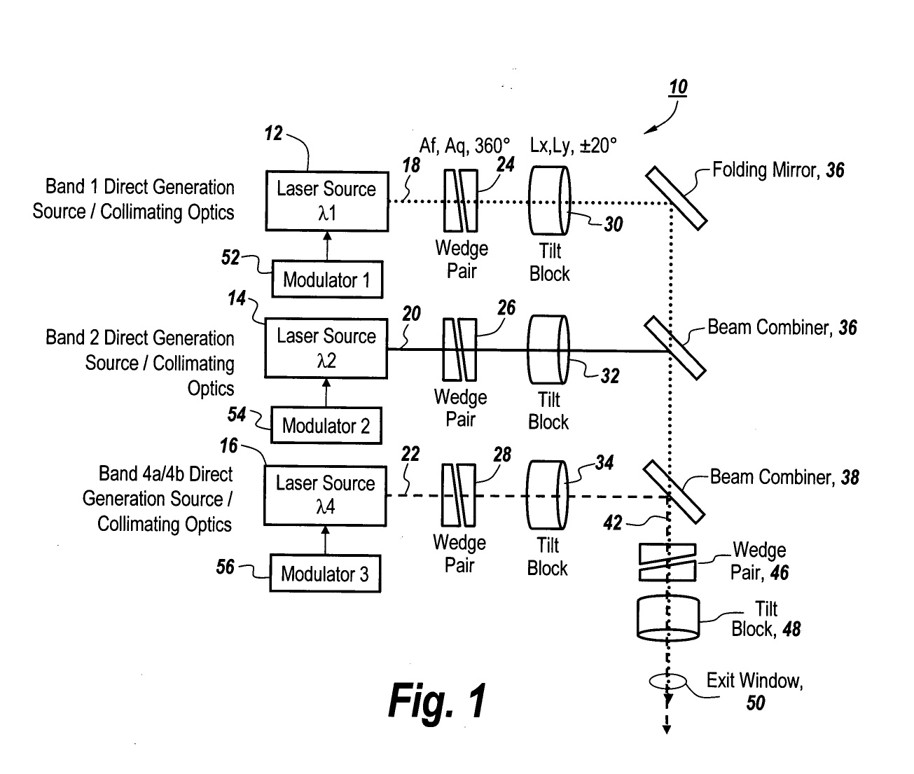

Referring now to FIG. 1, in a direct generation semiconductor DIRCM laser system 10 a number of direct generation laser sources 12, 14 and 16 utilize collimated optics to provide beams 18, 20 and 22 through respective wedge pairs 24, 26 and 28. In one embodiment, the wedge pairs are Risley prisms. The outputs from wedge pairs 24, 26 and 28 are respectively coupled through tilt blocks 30, 32 and 34 and impinge respectively on a folding mirror 36, a beam combiner 38 and another beam combiner 40. The result is an output beam 42 with jam code applied that passes through another wedge pair 46 and another tilt block 48 and out through an exit window 50.

Each of the laser sources 12, 14 and 16 is provided with independent jam code modulation by respective modulators 52, 54 and 56. Each of the modulators independently and asynchronously modulates the output of the associated laser source such that the modulation on laser beams 18, 20 and 22 may be specifically tailored for a particular band.

As mentioned above, the ability to separately modulate each of the laser sources as well as to control intensity and output provides for a multi-spectral beam which is highly tailored to all of the threats that the system may encounter.

Note also that the wedge pairs provide angular adjustment and the tilt blocks function as translational adjustment optics.

Note that all of the laser sources mentioned above are 1-10 watt lasers, with beam widths of 1 to 4 milliradians.

The semiconductor lasers available for the various bands are as follows. As for as the Band 1, indium phosphide lasers are available as traditional laser diodes. As for Band 2, gallium antimonide type 1 quantum well structures are utilized. Such lasers are described in an article entitled ‘Interband GaSb-based laser diodes for spectral regions of 2.3-2.4 μm and 3-3.1 μm with improved room temperature performance’ by Gregory Belenky, et. Al. Proc. SPIE Vol. 6900, 690004 (2008)

With respect to the band 4, quantum cascade devices are utilized that are based on indium phosphide substrates and have multiple stages as well as well material compositions. Such devices have been described in an article entitled ‘1.6 W high wall plug efficiency, continuous-wave room temperature quantum cascade laser emitting at 4.6 μm’ by A. Lyakh, et. Al. App. Phy. Let 92, 111110 (2008) These devices are manufactured by what is called by a non-resonant extraction technique, or a 2-phonon resonance technique.

What has been provided is a system which obviates a need for optical parametric oscillators and has an increased wall plug efficiency or WPE due to the fact of only generating light at the wavelengths required. The subject system utilizes direct generation semiconductors that take electrical power and convert it directly into the energy needed at the wavelength required which can be independently controlled. This makes the system the absolute optimal architecture for an IRCM laser, precisely because one puts out energy at the required bands and in which the energy in each of the bands is controlled separately, with the energy radiatable simultaneously in multiple bands, if desired.

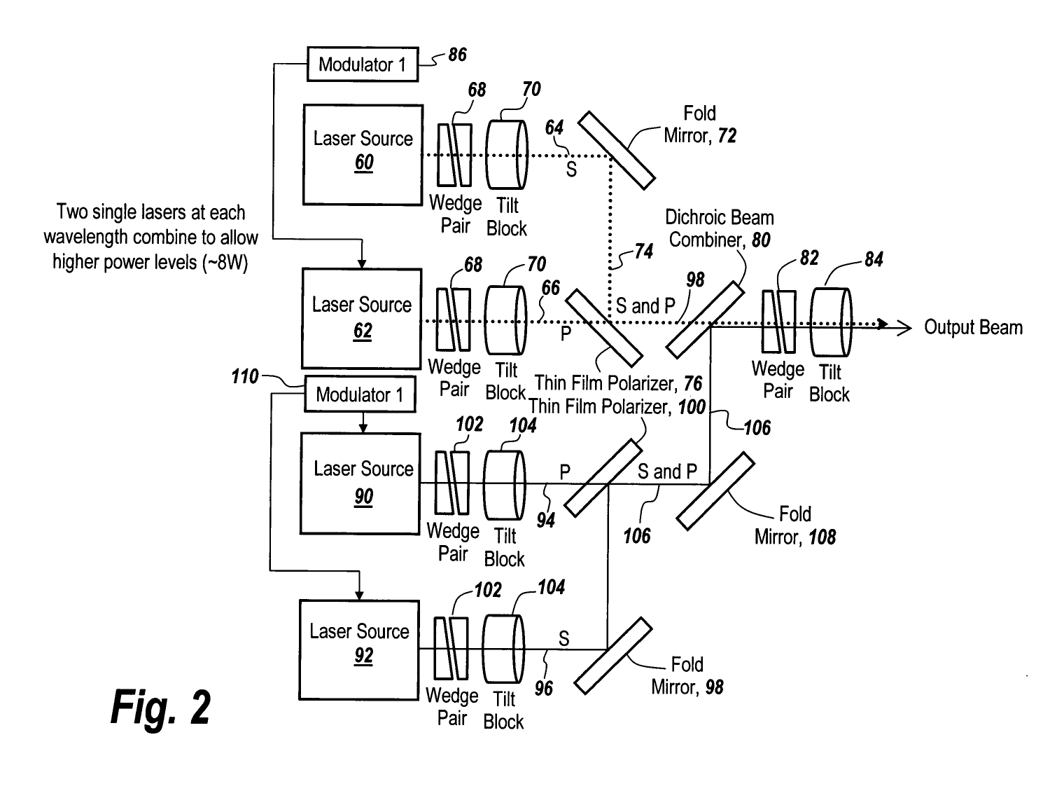

Referring to FIG. 2, the output of a single laser source can be doubled by utilizing two laser sources here illustrated at 60 and 62 which have outputs which are orthogonally polarized as indicated by S and P with respect to beams 64 and 66. Alignment optics including wedge pairs 68 and tilt blocks 70 provide alignment for the optical beams.

Beam 64 impinges upon folding mirror 72 which is redirected at 74 and impinges on a thin film polarizer 76 through which beam 66 having a different polarization is allowed to pass. Thus, beams 74 and 66 are combined through the utilization of the thin film polarizer such that energy having both polarizations, S and P, exist on beam 78. In one embodiment, this beam passes through a dichroic beam combiner 80 and through a wedge pair 82 and a tilt block 84 to provide an output beam that is twice the power of each of the individual lasers. Note that modulator 86 modulates laser sources 60 and 62 identically.

Thus for one band laser sources 60 and 62 are operative, whereas for a different band an identical laser system operating in a different band, here shown at 90 and 92 couple output beams 94 and 96. These beams are orthogonally polarized and are coupled to respective fold mirrors 98 and thin film polarizer 100 having passed through respective wedge pairs 102 and tilt blocks 104. The result is that the combined S and P beam 106 impinges upon fold mirror 108 and is redirected to dichroic beam combiner 80 to produce a second high power output beam combined with the first output beam.

Again laser sources 90 and 92 are identically modulated by a modulator 110.

What is shown is that it is possible to provide increased outputs utilizing multiple lasers in which each provides a polarized output, with the physical body of one laser offset by 90° with respect to the physical body of the other laser to provide the orthogonal polarization.

### Non-Directed Jamming

All of the above describes systems in which produce fairly tightly controlled laser beams on the order of 1 to 4 milliradians. These must be directed by a DIRCM head or pointing device that is to be aimed at the incoming target. As will be appreciated, these types of DIRCM heads are complicated and require extreme aiming accuracy in which the exact angular orientation of the incoming missile relative to the target platform must be ascertained and the beam pointed directly to the head of the missile. Not only must the missile be detected sufficiently in advance of impact to allow it to be jammed, also the beam must be slewed to the appropriate position to intercept the missile's guidance head. While the utilization of semiconductor lasers produces enough energy on target, the beam pointing is required.

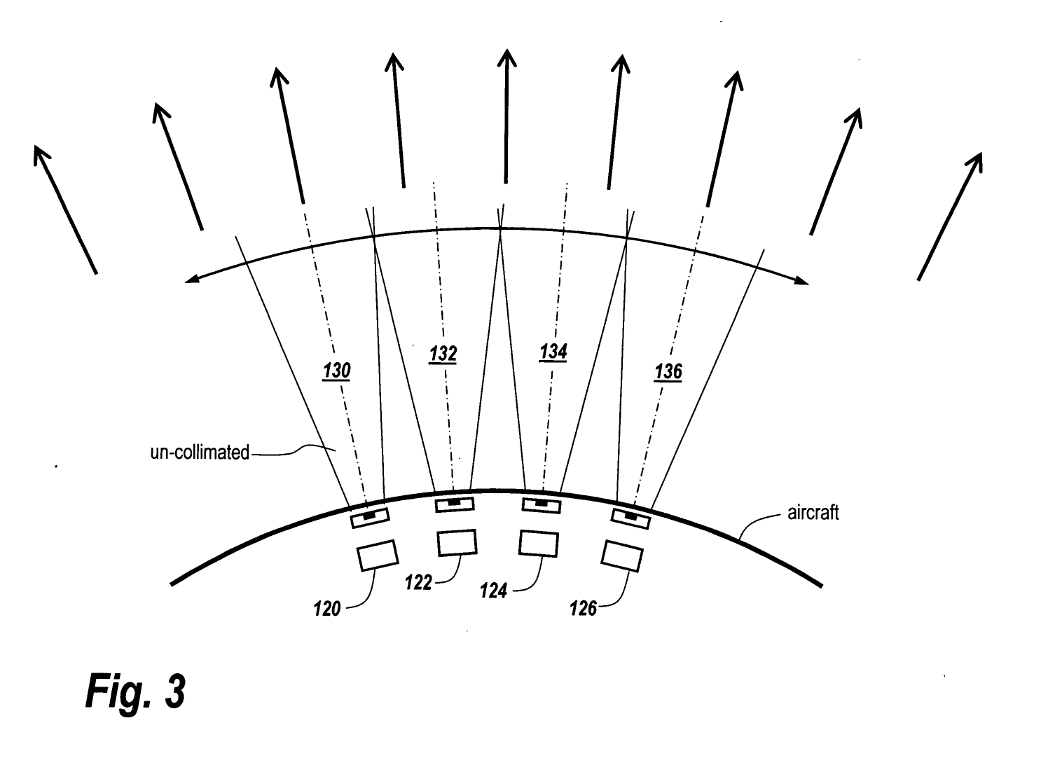

However, referring to FIG. 3, it is possible to arrange a number of semiconductor lasers 120, 122, 124 and 126 aimed at slightly different directions to provide beams 130, 132, 134 and 136 which are offset enough to provide for instance a 30° coverage angle or field of view. Lasers 120-126 constitute an array. Mounting a number of such arrays about a ring provides 360° coverage. Such an assembly may be mounted, for instance on a conventional lamp-based jammer to provide not only omni-directional coverage, but also optimal jam codes with appropriate modulation. Alternatively the arrays can be used independent of a lamp-based jammer.

Thus, what can be added to a traditional lamp-based jammer countermeasure device is a turret of semiconductor lasers, each operating in a designated band and with color temperature control to supplement the infrared source produced by the lamp-based jammer device. At the same time an appropriate jam code is provided which is more optimized than traditional lamp-based jammers are capable of.

While the subject system is shown attached to a lamp-based jammer device, it is of course recognized that any array of the semiconductor lasers may protect an airborne vehicle or land vehicle, as well as for instance any stationary object, without having to use either target warning systems or laser pointing devices. The result is that without utilizing beam alignment and linearity adjusting optics, one can utilize the raw outputs of these semiconductor lasers and group them and combine them so as to provide the required 360° coverage, thereby eliminating the problem of having to collimate and direct individual laser output beams.

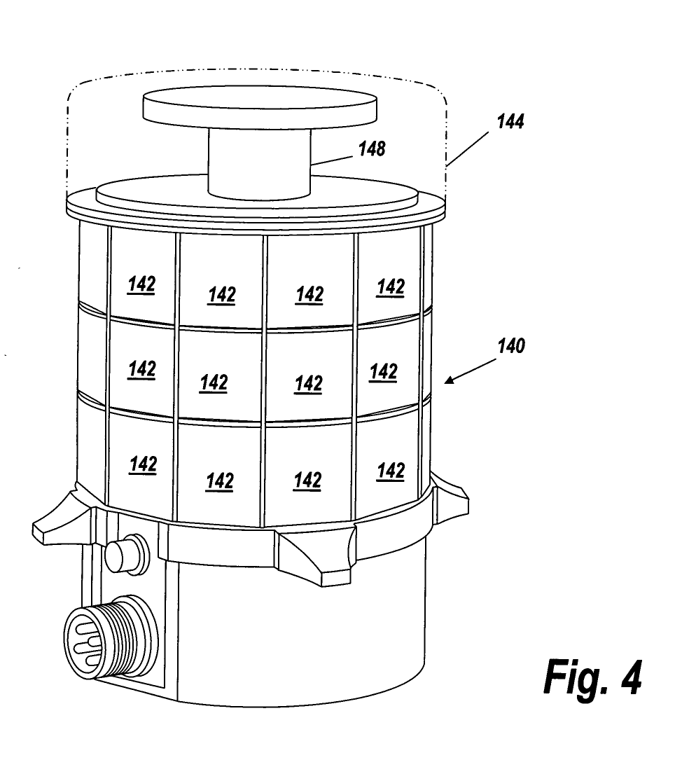

More particularly, and referring now to FIG. 4, a lamp-based jammer assembly 140 is provided with a high intensity infrared source that radiates omni-directionally out from infrared transmissive windows 142 such that the high intensity infrared lamp provides countermeasure radiation in an omni-directional pattern. As will be appreciated with lamp-based jammer devices, the radiation from the high intensity source may be modulated by mechanical modulators or electronically in the case of plasma arc-discharge sources.

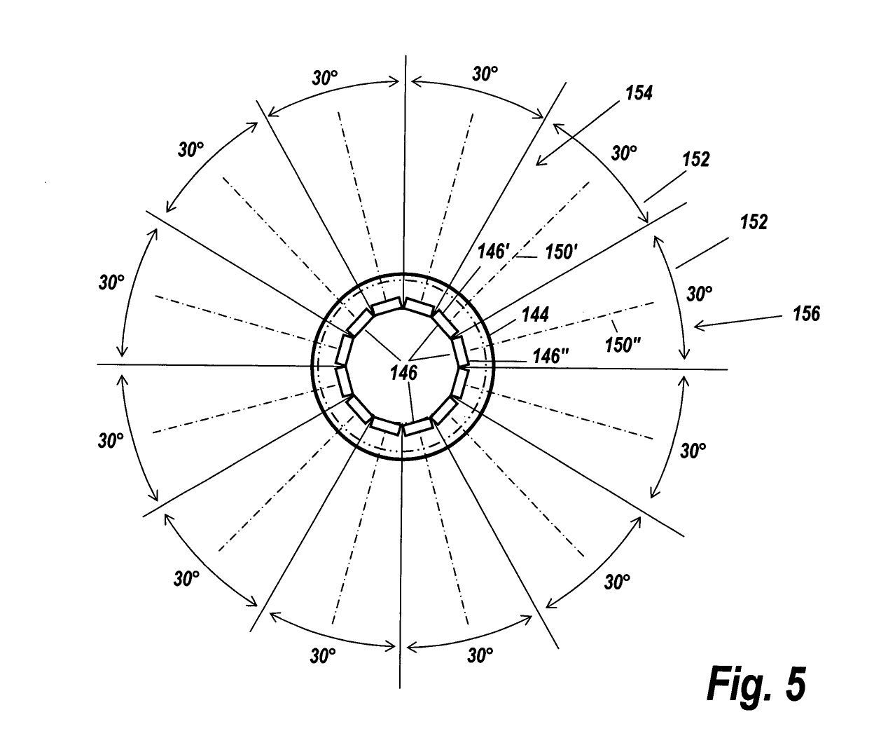

In order to augment or even supplant the infrared countermeasure radiation from the lamp-based jammer device, a turret 144 is placed on top of the lamp-based jammer device and houses a ring of direct generation semiconductor lasers at the periphery of the turret as shown by direct generation semiconductor lasers 146 in FIG. 5. Preferably the turret is provided with an internal stack or chimney 148 to vent the excess heat from the LAMPS module.

What will be seen in FIG. 5 in one embodiment is that each of the semiconductor lasers 146 has a centerline 150 such that the centerline from direct generation semiconductor laser 146′, namely centerline 150′, is offset from the centerline 150″ of direct generation semiconductor laser 146″. Note the above is one example of the potential orientations of the laser elements that in aggregate comprise the laser transmitter. It will however be appreciated that other 360° arrangements are within the scope of the invention.

As can be seen by arrows 152, the field of view or coverage of each of the direct generation semiconductor lasers is approximately 30° such that the centerlines of adjacent semiconductor lasers are offset by 30°, whereby the beams 154 and 156 are contiguous. With a 30° field of view for each of the semiconductor lasers, a 360° omni-directional coverage can be achieved with a ring of 12 semiconductor lasers.

It will be appreciated that the semiconductor lasers pictured in FIG. 5 may include a bar with a longitudinal PN junction. Alternatively, an array of semiconductor lasers may be located on a single substrate, aimed in such a way as to provide the required 30° field of view.

Note, the semiconductor lasers utilized may include an array of devices with selected elements in the array radiating in different infrared bands.

As described above, the output of the direct generation semiconductor lasers may be modulated independently for each band of interest and may provide a multi-spectral output as described above.

In one embodiment, the lamp-based jammer unit module or unit 140 is configured to be mounted on top of an aerial vehicle such as a helicopter to provide jamming radiation about the aerial vehicle. The location of the direct generation semiconductor lasers in the turret atop the lamp-based jammer module provides the lamp-based jammer countermeasure system with additional spectral flexibility as well as modulation flexibility, it being noted that the usual lamp-based jammer device operates in a single band and with a single jam code. Thus, the array of semiconductor lasers pointing in different directions can be used either by itself or in combination with the countermeasure capabilities of the lamp-based jammer module.

Note, there are three potential configuration classes of this type of transmitter, namely for a narrow field of view, the DIRCM laser, and for a wide field of view laser elements are arranged to augment the output of a lamp-based jammer, or the turret is used by itself to provide a wide field of view countermeasure function.

Thus the turret or like device may be used separately from a lamp-based jammer and provide the sole jamming functions. Such a turret is exceptionally lightweight, small, less expensive, easier to modulate and more efficient than lamp-based jammers.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. An infrared countermeasure laser jamming system comprising:
at least one direct generation semiconductor IRCM laser in which infrared energy is directly generated; and,
a modulator coupled to said semiconductor laser for modulating the output thereof with a jam code.

2. The system of claim 1, and further including a multiplicity of said direct generation semiconductor IRCM lasers, each of said semiconductor lasers being provided with an independent modulator, and a beam combiner coupled to the outputs of said semiconductor lasers for combining the outputs thereof.

3. The system of claim 2, wherein different ones of said semiconductor lasers operate in different energy bands.

4. The system of claim 3, wherein each of said modulators is provided with an optimal jam code for the associated band.

5. The system of claim 2, wherein the output of each of said lasers is adjustable such that when the output beams from said laser are combined, the combined output is provided with a predetermined color temperature.

6. The system of claim 5, wherein the output power of said lasers is adjustable so as to provide a multi-spectral combined beam having a controllable color ratio.

7. The system of claim 6, wherein said lasers are controlled in terms of waveform amplitude.

8. The system of claim 1, wherein said direct generation semiconductor laser is capable of being modulated in a pulsed mode, a Quasi-CW mode or a CW mode.

9. The system of claim 8, wherein the duty cycle for said laser ranges from 0 to 100%.

10. The system of claim 2, wherein said system has an all band coverage.

11. The system of claim 10, wherein said lasers operate respectively in the 1, 2, 4a and 4b bands and have outputs that are combined to provide a simultaneously-generated multi-color output beam.

12. The system of claim 11, wherein said multi-color output beam includes multiple jam code modulators, one for each of said bands.

13. The system of claim 1, and further including an identical semiconductor laser, each of said semiconductor lasers being provided with a polarized output, with the polarized output of one of said lasers being orthogonal to that of the other of said semiconductor lasers, the outputs of said lasers being passed through a polarized element in which the output from one of said lasers passes through unattenuated and the other of said output is reflected from the polarizer element and is combined with the unattenuated output, thus to provide a combined output having double the power of that associated with a single laser.

14. The system of claim 13, wherein each of said lasers is modulated with an identical jam code.

15. The system of claim 1, wherein said semiconductor laser includes one of an indium phosphide or gallium antimonide laser diode.

16. The system of claim 1, wherein said semiconductor laser includes a type 1 quantum well laser device.

17. The system of claim 1, wherein said laser operates in Band 4 and includes an indium phosphide quantum cascade laser device.

18. The system of claim 1, wherein said system operates at room temperature, thus enabling the use of thermoelectric cooling or passive cooling only without the need of cryogenic cooling.

19. The system of claim 1, wherein said laser employs one laser optical conversion phase, thus eliminating the need for pump lasers.

20. The system of claim 1, wherein said semiconductor laser can be operated in a continuous wave 100% duty factor mode, a QCW high duty factor mode with pulses from 1 microsecond to 1 millisecond and an output power of between 100 milliwatts and 10 watts, or in a pulse mode with pulse repetition frequency of greater than a 10 kHz and pulse width less than 1 μS.

21. The method of claim 20, wherein modes can be varied over time to meet operational requirements.

22. A system for providing infrared radiation for use in infrared countermeasuring, comprising:
a direct generation semiconductor IRCM laser.

23. The system of claim 22, and further including a multiplicity of said direct generation infrared lasers mounted such that the additive output contributions of the individual laser elements comprise an overall radiation pattern that comprehensively emanates from all required angles.

24. The system of claim 23, wherein the beams are offset as needed to create the optimal overall radiation pattern of the lasers, thus to provide as a combined beam width the sum of the beam widths of the individual lasers.

25. The system of claim 23, wherein the beams from said lasers are uncollimated.

26. The system of claim 25, wherein said uncollimated lasers are positioned about so as to provide 360° coverage.

27. The system of claim 25, and further including an infrared lamp and an assembly at said lamp housing said direct generation infrared semiconductor lasers to provide 360° coverage, whereby said 360° coverage augments the output from said infrared lamp.

28. A method for providing a multi-spectral infrared countermeasure beam having optimal jam codes for each of the multi-spectral bands, comprising the steps of:
providing a plurality of direct generation semiconductor IRCM lasers each operating in a different infrared band;
independently modulating each of the semiconductor lasers with a jam code that is optimal for the band in which it operates; and,
providing a beam combiner for combing the outputs of the semiconductor lasers such that the combined output beam contains optimal jam codes for the associated bands.

29. The method of claim 28, and further including the step of adjusting the outputs of the semiconductor lasers such that the combined output beam from the lasers exhibits a color temperature profile to approximate that of a predetermined jet engine.

30. The method of claim 29, wherein the temperature profile is defined by a color ratio that is in turn determined by control of the output power or the color output of the associated laser.

31. The method of claim 28, wherein each of the bands associated with the multi-color output are simultaneously generated, thereby reducing the threat defeat timeline.
